(19) United States
(12) Patent Application Publication
(10) Pub. No.: US 2011/0224967 A1
(43) Pub. Date: Sep. 15, 2011

(54) METHOD AND APPARATUS FOR AUTOMATICALLY MAGNIFYING A TEXT BASED IMAGE OF AN OBJECT

(76) Inventor: Michiel Jeroen Van Schaik, Breda (NL)

(21) Appl. No.: 12/999,367

(22) PCT Filed: Jun. 16, 2009
(86) PCT No.: PCT/NL2009/050351

§ 371 Date: Jun. 1, 2011

(30) Foreign Application Priority Data
Jun. 16, 2008 (NL) PCT/NL2008/050386

(51) Int. Cl. G06F 17/28; H04N 5/262; G06K 9/18; G10L 15/00

(52) U.S. Cl. 704/2; 348/240.2; 382/182; 704/231; 704/E11.001; 704/E15.001; 348/E05.055

(57) ABSTRACT

Method and apparatus for capturing a text based source image 5, 5A provided on an object 3 supported on a surface. Positioned above the object 3 is a camera 7 for capturing a view of the text based image 5, 5A. The camera 7, through lens 9 generates a focused image of at least part of the object 3 and transmits this image to a processor 11 for magnification of the image captured by the camera 7 to a size specified for display on a display device 15. In the processor 11 the magnification is effected to a rate that is controlled by the second predefined size for display 19, 19A of the font to appear on the display 15 and is independent of the first font size.

The invention relates to a method and apparatus for enlarging a text based image of an object. In particular the invention relates to a method and apparatus useful in assisting persons with impaired eyesight, low vision or other reading difficulties impairing reading and writing.

It has been found useful in such method and apparatus to employ a user adjusted rate of magnification; because type faces in a text based source may vary substantially in font size. The impaired reader may often have a personal viewing requirement limited to a particular size range of type faces. In a known method and apparatus, as disclosed in U.S. Pat. No. 6,731,326, adjustable magnification is obtained by changing the distance between a camera and an object and thereby altering the angle of view. This known arrangement requires the impaired reader to operate a manual control, whenever a font size in the text based source changes. Such is often the case with the difference between headlines and columns in newspapers.

Especially for visually impaired, often elderly, persons it would be desirable to reduce as many manual controls, and the need of using these, as much as possible on reading and writing magnifiers.

The only known method for automatic font display magnification in the prior art is to take a photo of the text, scan the text and recognize it and deliver the text in a displayed format as a column of words, a row of words, or a word at a time and in speech. This method of processing has the disadvantage of being complex in use, expensive and time consuming, and its output is a result of a processed image.

By contrast the object of the current invention is a simple, inexpensive, and instantly operating method and apparatus. An additional aim is to eliminate virtually all interface buttons on devices for carrying out the method of magnifying text based images,

Accordingly it is an object of the present invention to overcome or ameliorate at least one of the disadvantages of the prior art. It is also an object of the present invention to provide alternative structures which are less cumbersome in operation and which moreover can be made relatively inexpensively. Alternatively it is an object of the invention to at least provide the public with a useful choice.

To this end the invention provides for a method and apparatus as defined in the appended claims. With the invention all settings need to be personalized only once. So independent on what font size is under the camera, it will be automatically magnified to the desired font size to be displayed on the display screen. Once the user's preference has been established, varying sizes of type faces that are scanned do not require adjustment of the magnification rate. The apparatus according to the invention will thus always have the same setting when switched on and the required magnification rate is adjusted automatically by the device. Even a manual ON/OFF switch may be eliminated, by using an automatic proximity switch. Apart from the displayed font size, other functions like: contrast, brightness, or color enhancements can also be predefined to a user's requirements. The present invention thus directly and instantly auto-magnifies the subjected image or text as is in the pre-set font or letter size on the display.

According to another aspect of the invention it would also be advantageous for impaired readers to be provided with an option to convert type faces to a particular model of type face or font that is easier to distinguish than the type face model or font of the text based source. Further advantageous embodiments are defined in dependent sub claims included with the appended claims, as well as in the detailed description of preferred embodiments. Such preferred embodiments are described in reference to the accompanying drawings in which:

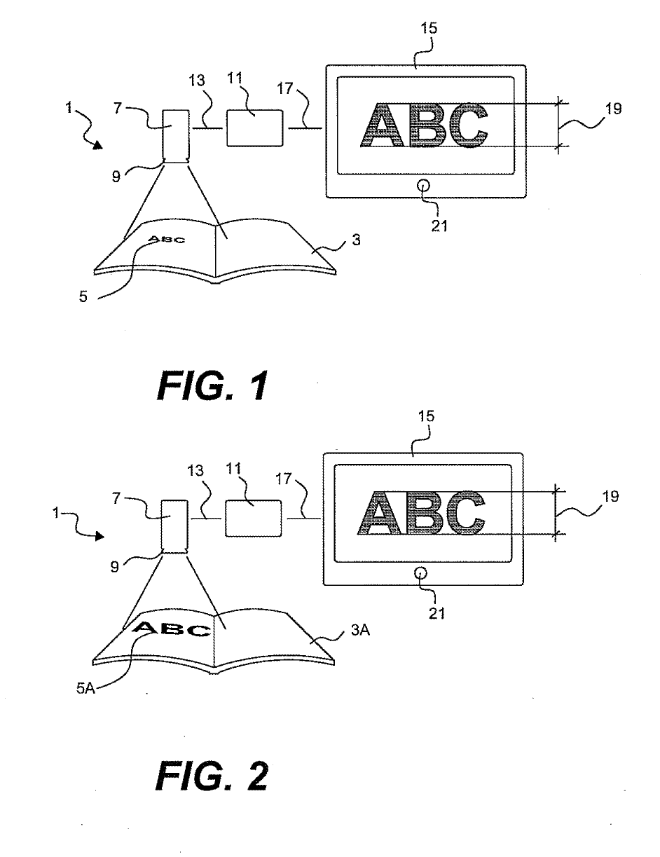

FIG. 1 is a schematic representation of an apparatus according to the invention being used with a first text based source image on an object;

FIG. 2 is a schematic representation of an apparatus according to the invention being used with a second text based source image on an object;

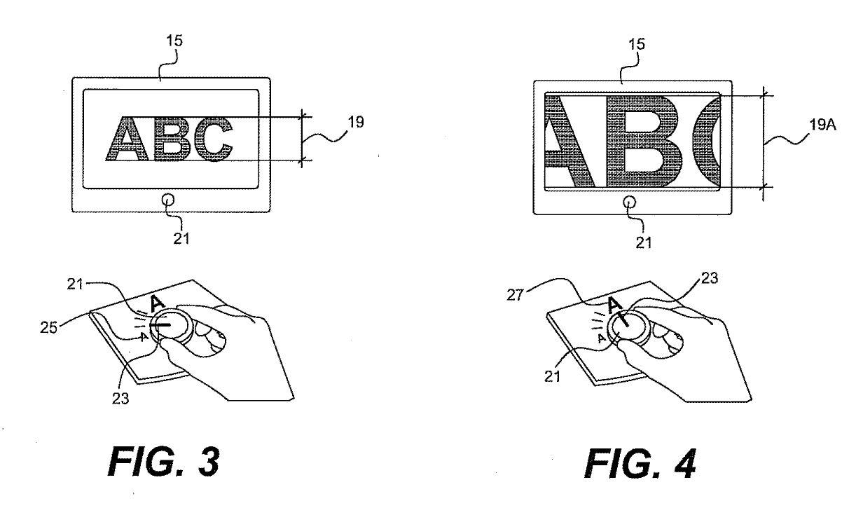

FIG. 3 is a schematic representation of a first size for display setting; and

FIG. 4 is a schematic representation of a second size for display setting.

In FIG. 1 an apparatus 1 is seen being used to capture an image from a text based source on an object, such as a book 3. A text 5 on the book 3 has characters represented as “ABC” of a first relatively small font size. An image capturing device, such as camera 7 is capturing an image from the page in the book 3 on which the text 5 is printed. The camera 7 is provided with an optical lens 9, which may have an automatic focus control as is known to the skilled person. The camera 7 is also connected to a processor 11, by means of a suitable wired or wireless first data transmission connection 13. The processor 11 is also connected to a display device 15 by means of a wired or wireless second data transmission connection 17. FIG. 2 shows the same apparatus 1 of FIG. 1, but being used with a different text based source image on a book 3A. The book 3A has a text 5A in the form of characters represented as “ABC” of a second relatively large font size. In all other respects the elements shown in FIG. 2 are identical to those shown in FIG. 1 and hence carry the same reference numerals. Comparing FIG. 2 with FIG. 1, it is seen that the character from the source image 5, respectively 5A, are displayed on the display device 15 in a font size with an identical height 19. This height can be preset by adjustment of a manual control knob 21, as will be further explained in reference to FIGS. 3 and 4.

FIG. 3 illustrates one size for display setting resulting in a displayed font size having a character height 19. It is seen that the manual control knob 21 is rotated anti-clockwise to have its pointer 23 aligned with a first size for display indication 25 on an arcuate scale. In FIG. 4 the manual control knob 21 is rotated clockwise to have the pointer 23 aligned with a second size for display indication 27 along the arcuate scale. This adjustment results in a display of the characters on the display device 15 with a larger character height 19A.

In use, the object with the text based source image 3 is provided on an object support surface (not shown but conventional). Positioned above the object 3 is the camera 7 for capturing a view of the text 5. The camera 7, through lens 9 generates a focused image of at least part of the object 3 and transmits this image to the processor 11 for magnification of the image captured by the camera 7 to a size specified for display on the display device 15. Alternatively, the camera 7 may be replaced by another image capture device, such as a scanner or the like. In the processor 11 the magnification is effected to a rate that is controlled by the second predefined size for display 19, 19A of the font to appear on the display 15 and independent of the first font size.

The method further can include analyzing a continuous video or photographic still source image obtained from camera 7 as to the first font size and determining the magnification rate for the image to be displayed as an enhanced video or photographic still display image on the display device 15. The processor may determine or measure a vertical size of characters in the source text and adjust magnification based on a desired size of representation on the display device 15.

Further the method may include digitalization of the video or photographic still source image. Using digitalization also enables optical character recognition. The recognized information from the text image 5, 5A can then be used in a recreation of text from the source image, using a different font type, different line spacing or different character spacing to enhance readability further.

In many cases it is also desirable for impaired readers to have the option to convert type faces to a particular model of type face or font that is easier to distinguish than the type face model or font of the text based source. The magnification rate for the second font size may further be arranged to be automatically variable between 3 times the first font size and 30 times the first font size. The second font size is preferably pre-selectable to character height 19, 19A having a value between 10 mm and 150 mm. Preselecting display parameters relating to contrast, brightness, resolution and/or color may be used as an additional feature to enhance reading for the visional impaired user. The text based source image 5, 5A containing fonts may also be enhanced for display by increasing brightness of the text in relation to its background, or by increasing darkness of the text in relation to the background.

Other enhancements may include negative image and/or false colors. Automatic translation from one recognized language into a predefined other language can also be included as an action performed by the processor 11. Color information in the source image may be manipulated to create a display image with either a reduced gray gradation or a reduced color gradation. Correction for color blindness can be offered by shifting colors in the source image to different colors in the display image.

The display 15 of the apparatus 1 may be a table top display, but alternatively it can also take the form of a spectacle mounted display (not shown but conventional). In all its variations the display is advantageously a liquid crystal display and preferably is a high resolution graphics array display. It can also be advantageous when the display device 15 is a wide screen version. Further the position and/or angle of the display, in at least some applications, is preferably adjustable for view.

Means for varying the magnification rate may be included in the processor 11, which may also include a microprocessor operating an automatic font size logarithm.

Automatic focus control is preferably included to focus the lens 9 of camera 7. Illumination means, such as a light source, may advantageously be employed to illuminate the source image 5, 5A. Such illumination means is not shown in the drawings, but is generally conventional and known to the skilled person. It is further possible to additionally equip the apparatus 1, i.e. the processor 11, with a microphone. The processer, when suitably provided with means for speech recognition, will then be capable of creating a text source for display on the display device 15 in the predefined second font size 19, 19A.

It is further useful for the apparatus according to the invention to include means for recognizing colored or gray-scale pictures or illustrations. Such means can be provided by the text recognition means, which when unable to recognize text will automatically initiate a maximum zoom-out and cause the high contrast mode for text recognition to shift to a suitable photo-mode. It is also possible to arrange the text magnifying apparatus to change to negative display mode when light colored characters on a dark background are recognized. With the same feature it is also possible to provide a user, if so desired, with white characters on a black background, irrespective of the source text being negative or positive.

It is thus believed that the operation and arrangement of the present invention will be apparent from the foregoing description. The invention is not limited to any embodiment herein described and, within the purview of the skilled person; modifications are possible which should be considered within the scope of the appended claims. Equally all kinematic inversions are considered inherently disclosed and to be within the scope of the present invention. The term comprising when used in this description or the appended claims should not be construed in an exclusive or exhaustive sense but rather in an inclusive sense. Expressions such as: “means for . . . ” should be read as: “component configured for . . . ” or “member constructed to . . . ” and should be construed to include equivalents for the structures disclosed. The use of expressions like: “critical”, “preferred”, “especially preferred” etc. is not intended to limit the invention. Features which are not specifically or explicitly described or claimed may be additionally included in the structure according to the present invention without deviating from its scope.

1. A method of automatically, directly and instantly magnifying a text based source image on an object containing fonts of a variable, undetermined, first size to a second predefined size for display, the method including:
providing the object with the text based source image;
positioning an image capture device in relation to the object to capture a view thereof;
generating a focused image of at least part of the object with the image capture device; and
transmitting the image to a display, wherein magnification is effected to a rate that is controlled by the second predefined size for display of the font to appear on the display and independent of the first font size.

2. The method of claim 1, further including analyzing a continuous video or photographic still source image as to the first font size and determining the magnification rate for the image to be displayed as an enhanced video or photographic still display image.

3. The method of claim 1, further including digitalization of the video or photographic still source image.

4. The method of claim 3, further including optical character recognition.

5. The method of claim 4, also including recreation of text from the source image, using at least one of a different font type, different line spacing and different character spacing.

6. The method of claim 1, wherein the magnification rate for the second font size is automatically variable between 3 times the first font size and 30 times the first font size.

7. The method of claim 1, wherein the second font size is pre-selectable to a value between 10 mm and 150 mm height.

8. The method of claim 1, also including preselecting display parameters relating to at least one of contrast, brightness, resolution and color.

9. The method of claim 8, wherein the text based source image containing fonts is enhanced for display by at least one of increasing brightness of the text in relation to background and darkness of the text in relation to background.

10. The method of claim 4, further including automatic translation from one recognized language into another predefined language.

11. The method of claim 8, wherein the color information in the source image is manipulated to create a display image with any one of a reduced gray gradation and a reduced color gradation.

12. The method of claim 8, wherein correction for color blindness is offered by shifting colors in the source image to different colors in the display image.

13. The method of claim 1, wherein an inability to recognize a source image to contain fonts or characters, automatically initiates a zoom-out of the image capture device and selection of a different contrast mode.

14. An apparatus for automatically magnifying a text based source image on an object containing fonts of a variable first size to a second predefined size for display, including:
an object support surface;
an image capture device;
a support for positioning and supporting the image capture device in relation to the object support surface;
a display for displaying the magnified image; and
a processor for transmitting and for magnifying an image captured by the image capture device to the display, wherein the processor includes means for varying the magnification in rate, in response to the second predefined size for display to appear on the display and independent of the first font size.

15. The apparatus of claim 14, wherein the display is a table top display.

16. The apparatus of claim 14, wherein the display is a spectacle mounted display.

17. The apparatus of claim 15, wherein the display is a liquid crystal display.

18. The apparatus of claim 14, wherein the display is a high resolution graphics array display.

19. The apparatus of claim 18, wherein the display is a wide screen version.

20. The apparatus of claim 14, wherein the display is adjustable for view.

21. The apparatus of claim 14, wherein the means for varying the magnification rate includes a microprocessor operating an automatic font size algorithm.

22. The apparatus of claim 14, wherein the image capture device is a camera and further including an automatic focus control to focus a lens used on the camera.

23. The apparatus of claim 14, further including illumination means, preferably a light source, to illuminate the source image.

24. The apparatus of claim 14, further including a microphone connected to the processer and means for speech recognition, capable of creating a text source for display in the predefined second font size.

25. The apparatus of claim 14, further including means to alter a zoom mode and a contrast mode of the image capture device in response to an inability to recognize text in the source image.
